(19) United States
(12) Patent Application Publication
(10) Pub. No.: US 2021/0345595 A1
(43) Pub. Date: Nov. 11, 2021

(54) Humane Pest Trap Apparatus

(71) Applicant: Gonzales Brown, Blair, SC (US)

(72) Inventor: Gonzales Brown, Blair, SC (US)

(21) Appl. No.: 16/866,722

(22) Filed: May 5, 2020

(51) Int. Cl. A01M 23/08; G08B 3/10; G08B 13/08

(52) U.S. Cl. CPC A01M 23/08; G08B 13/08; G08B 3/10

(57) ABSTRACT

A humane pest trap apparatus for capturing and releasing pests without harm includes a trap housing defining a trap interior. A top side has an entrance aperture and a right side has a release aperture extending through to the trap interior. A release door is hingeably coupled to the right side and selectively covers and uncovers the release aperture. A tube receiver is coupled to the trap housing. The tub receiver is coupled to the top side adjacent the entrance aperture. A tube has a tube wall extending from a trap end to an open end. The trap end is selectively engageable with the tube receiver to fully encompass the entrance aperture. The tube wall is substantially flexible to allow the open end to rest perpendicular to the ground.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pest control devices and more particularly pertains to a new pest control device for capturing and releasing pests without harm.

### (2) Description of Related Art Including Information Disclosed Under 37 CFR 1.97 and 1.98

The prior art relates to pest control devices. Existing pest control devices often cause harm to, or kill, pests in an inhumane and grotesque manner. Devices which seek to trap pests without causing harm typically rely on some type of complex mechanical trap door or a vacuum, whereas the present invention seeks to solve this problem simply with the entrance location and shape of the entrance. Furthermore, most existing devices either fail to adequately alert a user when a pest has been trapped or entirely lack an alert system.

### BRIEF SUMMARY OF THE INVENTION

An embodiment of the disclosure meets the needs presented above by generally comprising a trap housing having a front side separated from a back side, a left side separated from a right side, and a top side separated from a bottom side defining a trap interior. The top side has an entrance aperture extending through to the trap interior and the right side has a release aperture extending through to the trap interior. A release door is coupled to the trap housing. The release door is hingeably coupled to the right side and selectively covers and uncovers the release aperture. A tube receiver is coupled to the trap housing. The tub receiver is coupled to the top side adjacent the entrance aperture. A tube has a tube wall extending from a trap end to an open end. The trap end is selectively engageable with the tube receiver to fully encompass the entrance aperture. The tube wall is substantially flexible to allow the open end to rest perpendicular to the ground.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a humane pest trap apparatus according to an embodiment of the disclosure.

FIG. 2 is a top plan view of an embodiment of the disclosure.

FIG. 3 is a side elevation view of an embodiment of the disclosure.

FIG. 4 is a cross-sectional view of an embodiment of the disclosure.

FIG. 5 is a cross-sectional view of an embodiment of the disclosure.

FIG. 6 is an isometric view of an embodiment of the disclosure.

### DETAILED DESCRIPTION OF THE INVENTION

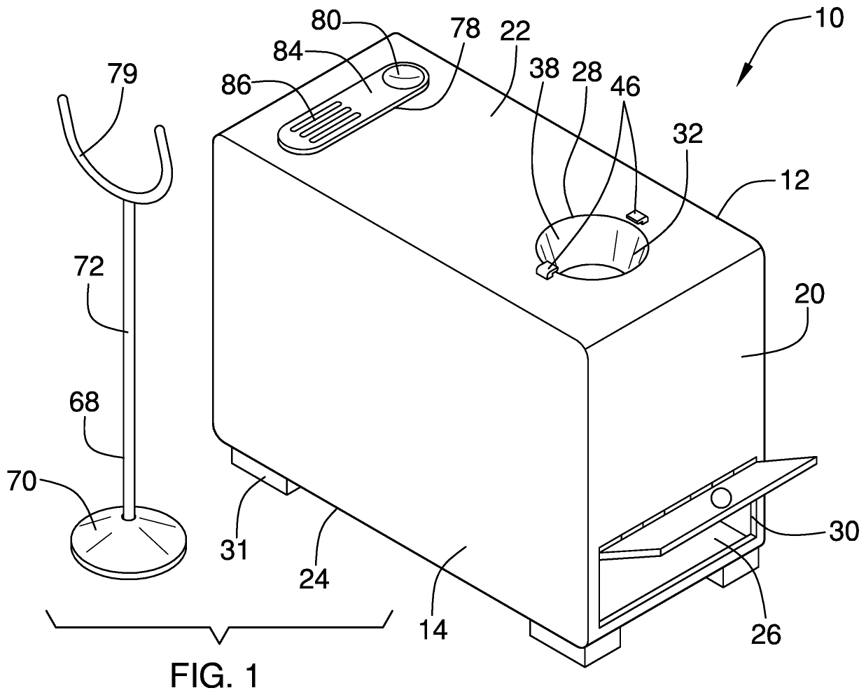

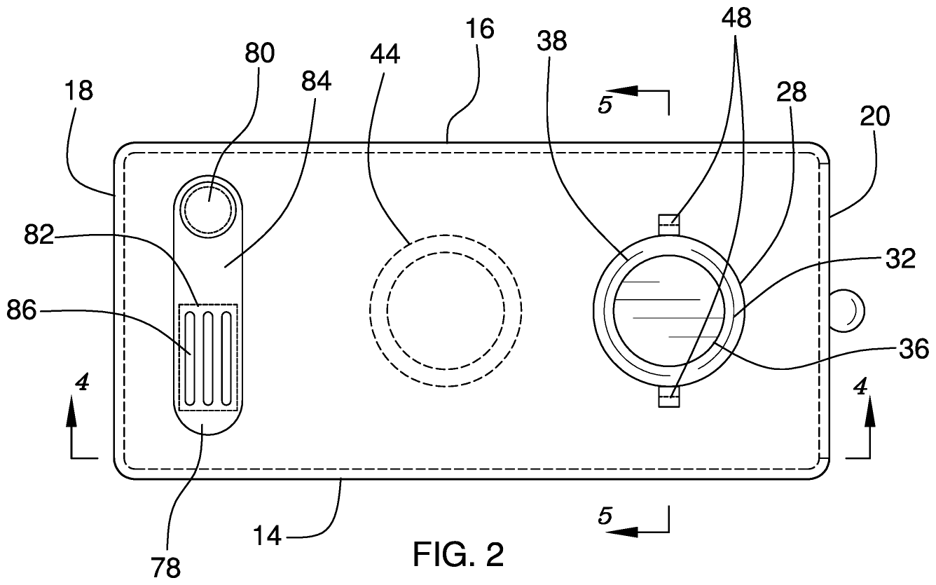

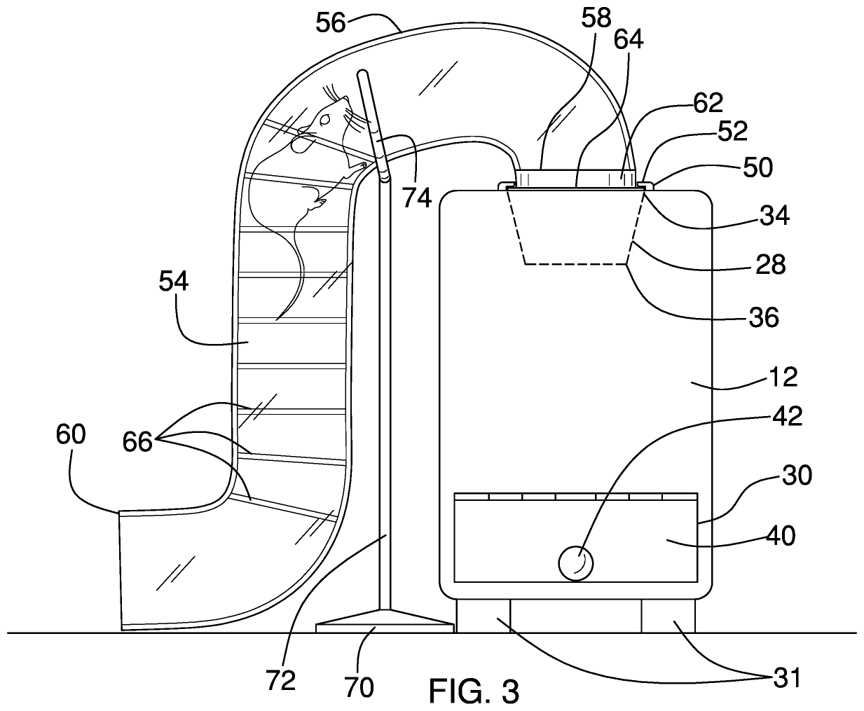

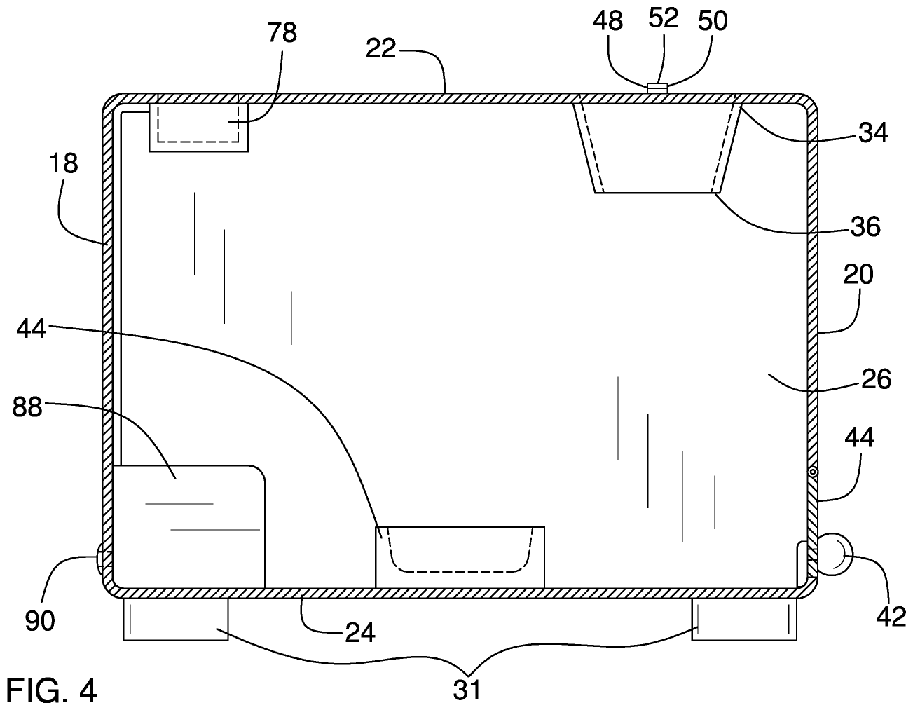

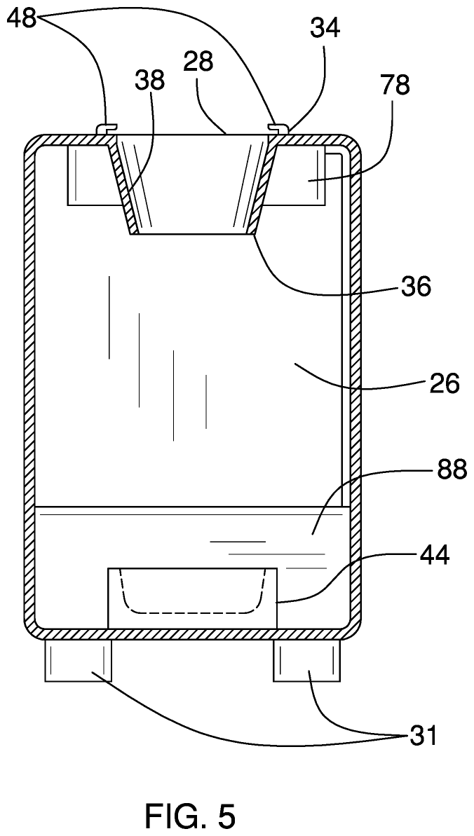

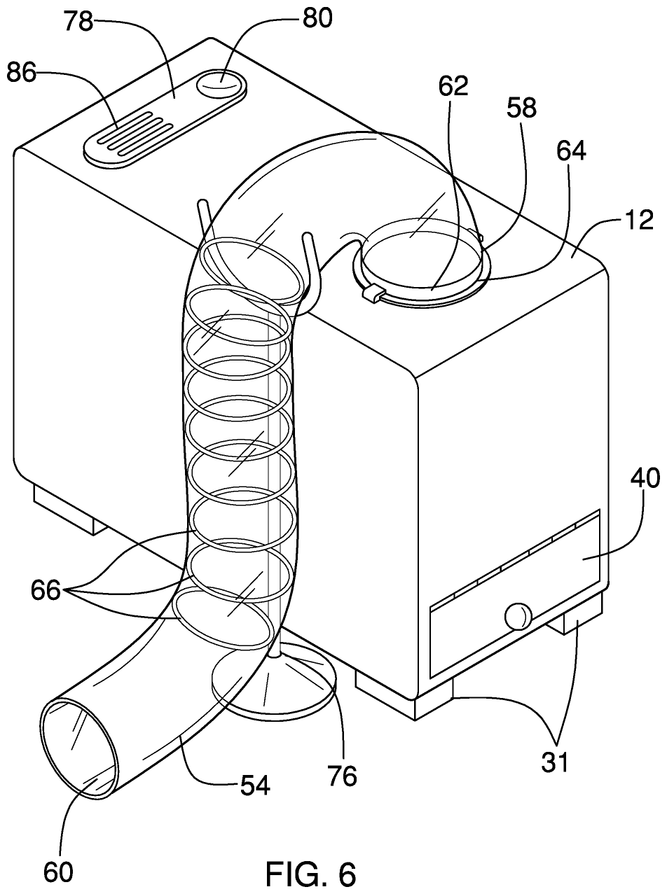

With reference now to the drawings, and in particular to FIGS. 1 through 6 thereof, a new pest control device embodying the principles and concepts of an embodiment of the disclosure and generally designated by the reference numeral 10 will be described.

As best illustrated in FIGS. 1 through 6, the humane pest trap apparatus 10 generally comprises a trap housing 12 having a front side 14 separated from a back side 16, a left side 18 separated from a right side 20, and a top side 22 separated from a bottom side 24 defining a trap interior 26. The top side 22 has an entrance aperture 28 extending through to the trap interior 26 and the right side 20 has a release aperture 30 extending through to the trap interior 26. The trap housing 12 is proportioned such that a height between the bottom side 24 and the top side 22 is a manageable drop for a common pest, such as a mouse or a rat, but not a height that can be jumped. The pest may thus enter the trap housing 12 safely but cannot escape once inside. A plurality of feet 31 may be coupled to the bottom side 24 to support and stabilize the trap housing 12 on uneven terrain.

A tapered entrance 32 may be coupled to the trap housing 12. The tapered entrance 32 is coupled to the top side 22 around the entrance aperture 28 within the trap interior 26. An upper rim 34 of the tapered entrance 32 conforms to the entrance aperture 28 and a lower rim 36 is smaller than the upper rim 34 to further prevent the pest from escaping, although proportioned to allow the pest to enter. An inner surface 38 of the tapered entrance 32 may be a smooth, low-friction material to encourage the pest to slide in to the trap housing 12 and to help prevent escape. A release door 40 is hingeably coupled to the right side 20 and selectively covers and uncovers the release aperture 30. The release door 40 may have a knob 42 to more easily be manipulated. The release door 40 in a closed position rests flush with the right side 20 and may be secured with a press-fit, a catch, a latch or other similar mechanism to prevent the pest from being able to force the release door 40 open from within the trap interior 26. The release door 40 may alternatively be slidably coupled to the right side 20, requiring a translational movement to be opened which cannot be performed by the pest. A bait bowl 44 may be selectively placed within the trap interior 26 on the bottom side 24 and is configured to hold pest bait to lure the pest into the trap housing 12. The bait bowl 44 allows the pest bait to be easily changed without requiring the trap housing 12 be cleaned.

A tube receiver 46 is coupled to the top side 22 adjacent the entrance aperture 28. The tube receiver 46 may have at least two tube clips 48 coupled to the top side 22. Each tube clip 48 has a riser portion 50 extending vertically from the top side 22 and a horizontal portion 52 extending perpendicularly from the riser portion 50 towards the entrance aperture 28. A tube 54 has a tube wall 56 extending from a trap end 58 to an open end 60. The trap end 58 is selectively engageable with the tube receiver 46 to fully encompass the entrance aperture 28 to encourage the pest to enter the entrance aperture 28. The trap end 58 of the tube may have a collar 62 with a lip 64 of the collar being selectively engageable under the horizontal portion 52 of each tube clip. The trap end 58 may thus be securely attached to the tube receiver 46 to prevent accidental disconnection from the weight and movement of the pest. Flexibility within the tube clips 48 between the riser portion 50 and the horizontal portion 52 allows the lip 64 to detach. Alternatively, each tube clip 48 may be pivotably coupled to the top side 22 such that it can be rotated away from the entrance aperture 28 to free the lip 64. The tube wall 56 may be substantially flexible to allow the open end 60 to rest perpendicular to the ground, providing the easiest possible entrance for the pest as well as controlled placement of the open end 60 in a tight area in which the trap housing 12 may not fit. The tube wall 56 may include a plurality of circular support ribs 66 to prevent the tube wall 56 from pinching while maintaining flexibility.

A tube stand 68 comprises a base 70, a post 72 extending from the base 70, and a support 76 coupled to the post 72. The support 76 is configured to selectively engage the tube wall 56 to position the tube 54 to remove stress from the connection between the trap end 58 and the tube receiver 46. The tube stand 68 may be dimensioned to position the support 76 above the top side 22 of the trap housing to further reduce this stress and to accommodate the bend in the tube 54. The support 76 may be U-shaped and may lie in a plane not coplanar with a plane of the post 72 to appropriately angle the tube 54.

A sensor 78 may be coupled to the trap housing 12. The sensor 78 may have a motion detector 80 and a speaker 82 is configured to generate an auditory alert when the pest is detected within the trap interior 26. An upper face 84 of the sensor may extend through the top side 22 of the trap housing. The upper face 84 includes a speaker grille 86 to make the speaker 82 as audible as possible. The sensor 78 requires a power source and may include a rechargeable battery 88 too allow placement of the apparatus 10 in locations without a power outlet, including outdoors. The rechargeable battery 88 is coupled to the bottom side 24 within the trap interior 26 to lower the center of gravity of the apparatus 10 and prevent tipping from movement of the pest. A charging port 90 may extend through the left side 18 to allow for convenient recharging of the rechargeable battery 88.

In use, the trap housing 12 is placed near a suspected location of a pest and the tube 54 is positioned with the open end 60 as close as possible on the ground. Pest bait is placed within the bait bowl 44 and the release door 40 is secured shut. Once the pest enters the trap interior 26, the motion detector 80 triggers the sensor 78 to play the auditory alarm through the speaker 82 to notify the user. The entire apparatus 10 may then be carried to the desired release location where the release door 40 is opened to free the pest.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A humane pest trap apparatus comprising:
a trap housing having a front side separated from a back side, a left side separated from a right side, and a top side separated from a bottom side defining a trap interior, the top side having an entrance aperture extending through to the trap interior, the right side having a release aperture extending through to the trap interior;
a release door coupled to the trap housing, the release door being hingeably coupled to the right side and selectively covering and uncovering the release aperture;
a tube receiver coupled to the trap housing, the tub receiver being coupled to the top side adjacent the entrance aperture; and
a tube having a tube wall extending from a trap end to an open end, the trap end being selectively engageable with the tube receiver to fully encompass the entrance aperture, the tube wall being substantially flexible to allow the open end to rest perpendicular to the ground.

2. The humane pest trap apparatus of claim 1 further comprising a tapered entrance coupled to the trap housing, the tapered entrance being coupled to the top side around the entrance aperture within the trap interior.

3. The humane pest trap apparatus of claim 1 further comprising the tube receiver having at least two tube clips coupled to the top side, each tube clip having a riser portion extending vertically from the top side and a horizontal portion extending perpendicularly from the riser portion towards the entrance aperture; the trap end of the tube having a collar, a lip of the collar being selectively engageable under the horizontal portion of each tube clip.

4. The humane pest trap apparatus of claim 1 further comprising a bait bowl, the bait bowl being selectively placed within the trap interior on the bottom side and configured to hold pest bait.

5. The humane pest trap apparatus of claim 1 further comprising a tube stand, the tube stand comprising a base, a post extending from the base, and a support coupled to the post, the support being configured to selectively engage the tube wall.

6. The humane pest trap apparatus of claim 5 further comprising the tube stand being dimensioned to position the support above the top side of the trap housing.

7. The humane pest trap apparatus of claim 5 further comprising the support being U-shaped and lying in a plane not coplanar with a plane of the post.

8. The humane pest trap apparatus of claim 1 further comprising a sensor coupled to the trap housing, the sensor being configured to generate an auditory alert when a pest is detected within the trap interior.

9. The humane pest trap apparatus of claim 8 further comprising the sensor being coupled to the top side within the trap interior, the sensor having a motion detector and a speaker.

10. The humane pest trap apparatus of claim 8 further comprising an upper face of the sensor extending through the top side of the trap housing.

11. The humane pest trap apparatus of claim 1 further comprising the tube wall having a plurality of circular support ribs.

12. A humane pest trap apparatus comprising:
a trap housing having a front side separated from a back side, a left side separated from a right side, and a top side separated from a bottom side defining a trap interior, the top side having an entrance aperture extending through to the trap interior, the right side having a release aperture extending through to the trap interior;
a tapered entrance coupled to the trap housing, the tapered entrance being coupled to the top side around the entrance aperture within the trap interior;
a release door coupled to the trap housing, the release door being hingeably coupled to the right side and selectively covering and uncovering the release aperture;
a bait bowl, the bait bowl being selectively placed within the trap interior on the bottom side and configured to hold pest bait;
a tube receiver coupled to the trap housing, the tub receiver being coupled to the top side adjacent the entrance aperture, the tube receiver having at least two tube clips coupled to the top side, each tube clip having a riser portion extending vertically from the top side and a horizontal portion extending perpendicularly from the riser portion towards the entrance aperture;
a tube having a tube wall extending from a trap end to an open end, the trap end being selectively engageable with the tube receiver to fully encompass the entrance aperture, the trap end of the tube having a collar, a lip of the collar being selectively engageable under the horizontal portion of each tube clip, the tube wall being substantially flexible to allow the open end to rest perpendicular to the ground, the tube wall having a plurality of circular support ribs;
a tube stand, the tube stand comprising a base, a post extending from the base, and a support coupled to the post, the support being configured to selectively engage the tube wall, the support being U-shaped and lying in a plane not coplanar with a plane of the post; and
a sensor coupled to the trap housing, the sensor being configured to generate an auditory alert when a pest is detected within the trap interior, comprising an upper face of the sensor extending through the top side of the trap housing.
